(19) United States
(12) Patent Application Publication
(10) Pub. No.: US 2005/0284878 A1
(43) Pub. Date: Dec. 29, 2005

(54) Window protective membrane dispenser

(76) Inventor: Hsiu-Man Yu Chen, Taichung (TW)

Correspondence Address: TROXELL LAW OFFICE PLLC;SUITE 1404, 5205 LEESBURG PIKE, FALLS CHURCH, VA, 22041, US

(21) Appl. No.: 10/875,195

(22) Filed: Jun. 25, 2004

(51) Int. Cl. B42F 13/00; B65H 1/00; B65H 49/34

(52) U.S. Cl. 221/33; 242/564.2

(57) ABSTRACT

A window protective membrane dispenser includes two connecting rods provided between two fixing plates. Each connecting rod consists of an outer sleeve and an inner telescopic tube movably fitted together and able to be separated from each other. The inner telescopic tube is provided thereon with two elastic engage elements and the outer sleeve has its wall bored with an engage hole for the elastic engage element to be engaged therein. The elastic engage element and the engage hole can be engaged with each other after the outer sleeve and the inner telescopic tube are pulled outward or pushed inward for a proper distance. Thus, the distance between two rolling members respectively fixed on the two fixing plates can be adjusted for facilitating fitting of membrane reels of different lengths, so the dispenser is quick and convenient in handling.

### BACKGROUND OF THE INVENTION

1. Field of the Invention

This invention relates to a window protective membrane dispenser, particularly to one provided with two connecting rods respectively composed of an outer sleeve and an inner telescopic tube, which can be separated from each other and adjusted in length, enabling membrane reels of different lengths to be fitted thereon.

2. Description of the Prior Art

A conventional window protective membrane dispenser includes two connecting rods assembled between two fixing plates having their inner walls respectively provided with a rolling member for the opposite ends of a membrane reel to be fitted thereon. One of the two connecting rods is provided thereon with a tightening belt for fastening the disperser on a user's waist to carry out pasting membrane on a window glass by turning the two rolling members together with the membrane reel.

However, windows are different from one another in size; therefore, membrane reels of a same length cannot meet various requirements in pasting work. In other words, a comparatively long membrane reel is required for pasting membrane on a comparatively large window so as to heighten efficiency of pasting work, lower cost for window protective membrane pasting and achieve substantially great economical gain. In addition, to assemble a membrane reel on the conventional window protective membrane dispenser, one of the two fixing plates has to be unscrewed and disassembled first and, after the membrane reel is fitted in position, this fixing plate has to be screwed in positioned again, necessary to employ auxiliary tools for fitting and taking-off of the membrane reel and inconvenient in use.

### SUMMARY OF THE INVENTION

The objective of the invention is to offer a window protective membrane dispenser, which has two connecting rods provided between two fixing plates. Each connecting rod is composed of an outer sleeve and an inner telescopic tube, which can be separated from each other and adjusted in length. The inner telescopic tube is provided with two elastic engage elements and the outer sleeve is bored with an engage hole to be engaged with the elastic engage element. Thus, after the outer sleeve and the inner telescopic tube are pulled outward or pushed inward to a proper distance, they can be fixedly secured by mutual engagement of the engage element of the inner telescopic tube and the engage hole of the outer sleeve, able to control the distance between the two rolling members on the two fixing plates.

The feature of the invention is two opposite rolling members, whose interval can be adjusted for fitting membrane reels of different lengths to carry out membrane pasting, heightening efficiency of membrane pasting work. In addition, the inner telescopic tube and the outer sleeve can be pulled outward or pushed inward to a certain distance and then fixed in position simply by pressing downward the elastic engage element of the inner telescopic tube, quick and easy in fitting or taking-off of a membrane reel.

### BRIEF DESCRIPTION OF DRAWINGS

This invention will be better understood by referring to the accompanying drawings, wherein:

FIG. 1 is a perspective view of a first preferred embodiment of a window protective membrane dispenser in the present invention:

FIG. 2 is an exploded perspective view of the first preferred embodiment of the window protective membrane dispenser in the present invention:

FIG. 3 is a side cross-sectional view of the engage portion in the first preferred embodiment of the window protective membrane disperser in the present invention:

FIG. 4 is a perspective view of the first preferred embodiment of the window protective membrane dispenser in the present invention, showing that two connecting rods are adjusted in length:

FIG. 5 is a perspective view of a second preferred embodiment of a window protective membrane dispenser in the present invention:

FIG. 6 is an exploded perspective view of the second preferred embodiment of the window protective membrane dispenser in the present invention: and

FIG. 7 is a side cross-sectional view of the engage portion in the second preferred embodiment of the window protective membrane disperser in the present invention.

### DETAILED DESCRIPTION OF THE PREFERRED EMBODIMENT

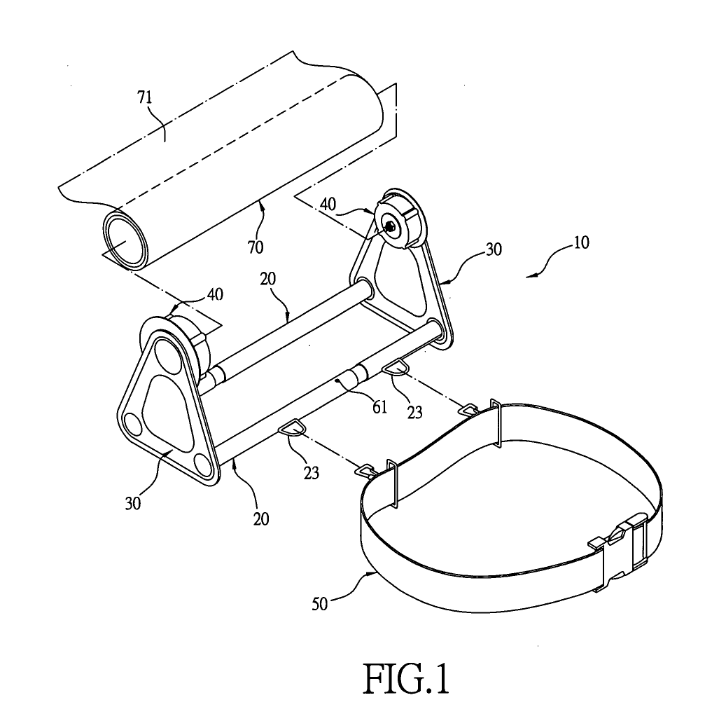

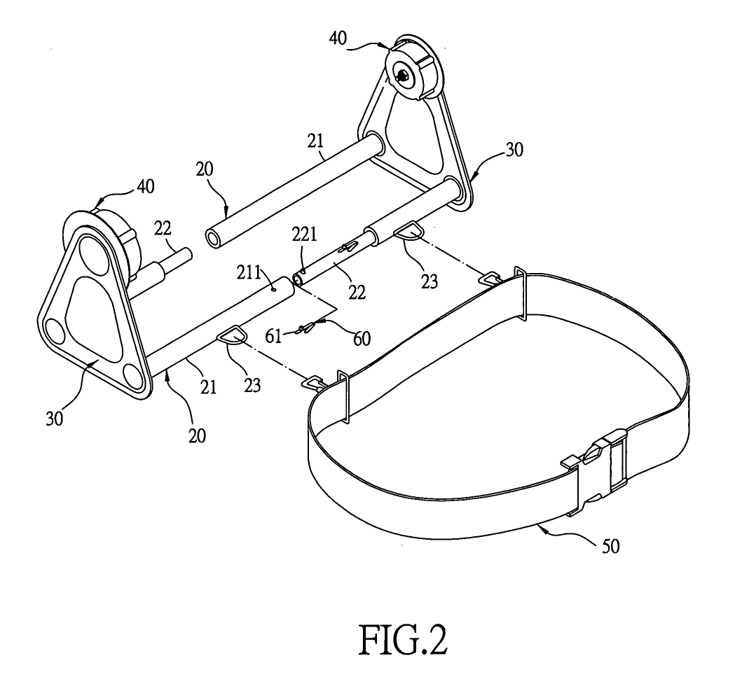

A first preferred embodiment of a window protective membrane dispenser 10 in the present invention, as shown in FIGS. 1 and 2, includes two connecting rods 20 having the two opposite ends respectively secured with a fixing plate 30. The two fixing plates 30 respectively have a rolling member 40 symmetrically and pivotally provided at a preset location on the inner wall for fitting the opposite ends of a membrane reel 70. Thus, when the membrane reel 70 is rotated together with the two rolling members 40, the membrane 71 on the membrane reel 70 can be released and pasted on a window glass. One of the two connecting rods 20 is fixed thereon with a tightening, belt 50 for fastening the dispenser 10 on a user's waist.

Each connecting rod 20 consists of an outer sleeve 21 and an inner telescopic tube 22 respectively having the outer end symmetrically welded on the inner wall of the two fixing plates 30, and the inner telescopic tube 22 has its inner end movably fitted in the inner end of the outer sleeve 21. Further, one of the two inner telescopic tubes 22 has the outer surface of its inner ends bored lengthwise with two through holes 221 aligned to each other, and the corresponding outer sleeve 21 has the outer surface of its inner end bored with an engage hole 211 corresponding with either of the two through holes 221 of the inner telescopic tube 22. Furthermore, one of the two outer sleeves 21 and the corresponding inner telescopic tube 22 are respectively welded with a hooking ring 23 at a preset location on the outer surface for hooking two ends of a tightening belt 50.

Two elastic engage members 60 are V-shaped elastic strips respectively received in advance in the inner telescopic tube at a place where the through hole 221 is located. Each engage member 60 has the outer surface of one end fixed with a projecting stud 61 elastically extending out of the inner telescopic tube 22 through the through hole 221 to engage with the engage hole 211 of the outer sleeve 21 for fixing the outer sleeve 21 and the inner telescopic tube 22 together.

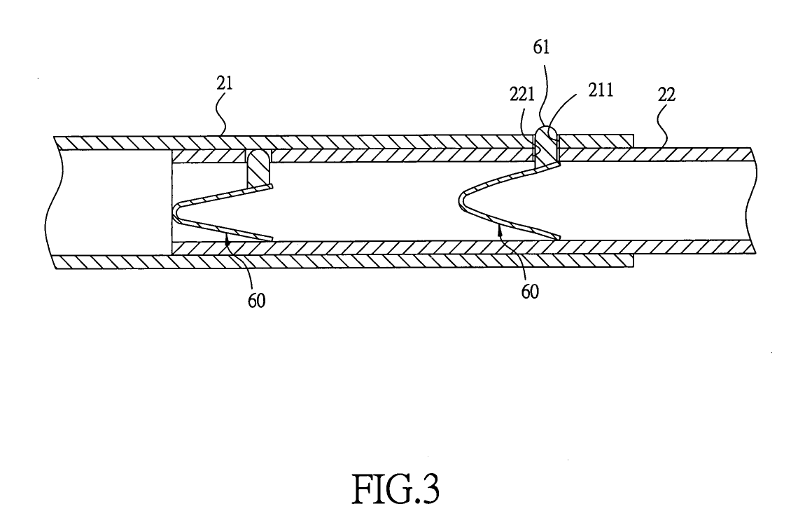

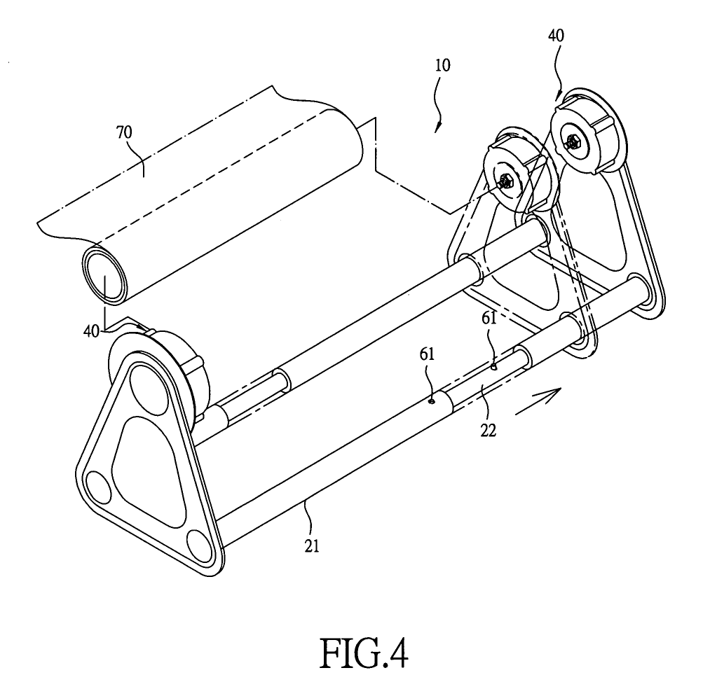

Since the distance between the two rolling members 40 of the dispenser 10 in the present invention is adjustable, membrane reels 70 of different lengths can be fitted thereon. In assembling, as shown in FIGS. 3 and 4, firstly, press downward the projecting stud 61 of the engage element 60 to let it shrink in the engage hole 211 of the outer sleeve 21. Next, the outer sleeve 21 and the inner telescopic tube 22 are respectively pulled outward for a preset distance to let the projecting stud 61 near the free end of the inner telescopic tube 22 engaged in the engage hole 211 of the outer sleeve 21 so as to lengthen the distance between the two rolling members 40 on the two fixing plates 30. Subsequently, the membrane reel 70 has one end fitted with one rolling member 40, and the projecting stud 61 near the free end of the inner telescopic tube 22 is pressed downward to enable the outer sleeve 21 and the inner telescopic tube 22 to be pushed inward and let the projecting stud 61 distant from the free end of the inner telescopic tube 22 move to engage in the engage hole 211 of the outer sleeve 21. Lastly, the membrane reel 70 has the other end fitted with the other rolling member 40, thus finishing fitting of the membrane reel 70.

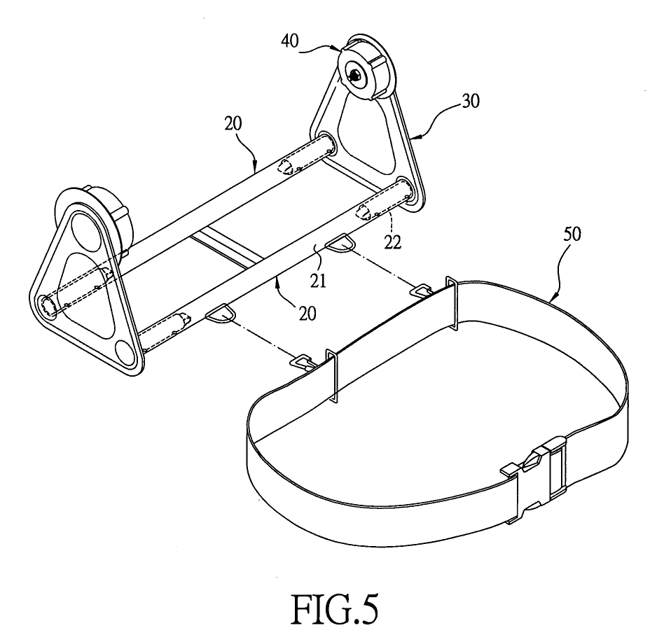

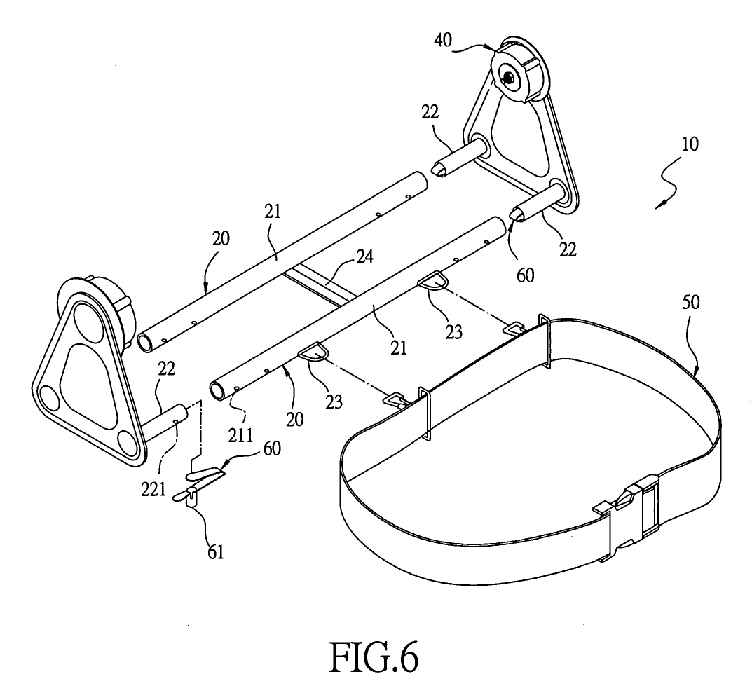

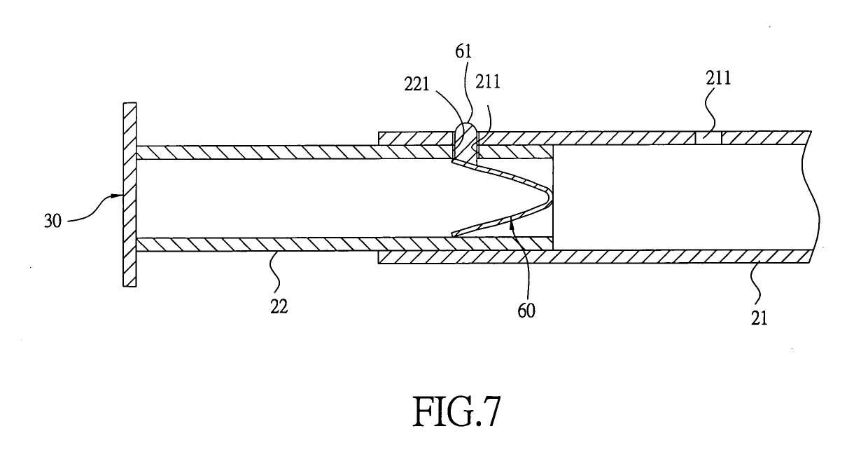

Next, a second preferred embodiment of a window membrane protective dispenser in the present invention, as shown in FIGS. 5, 6 and 7, includes two connecting rods 20 respectively con si sting of an outer sleeve 21 and two inner telescopic tubes 22. The two inner telescopic tubes 22 respectively have one end fixedly welded on the inner wall of a fixing plate 30 and the other end fitted in one end of the outer sleeve 21 to slide therein. Each inner telescopic tube 22 has the outer surface of its inner end bored with a through hole 221 for the projecting stud 61 secured on one end of an engage element 60 to elastically extend out therethrough. Each outer sleeve 21 has the outer walls of its opposite fitted ends respectively and lengthwise bored with two engage holes 211 spaced apart in line. By so designing, the projecting stud 61 elastically extending out of the inner end of the inner telescopic tube 22 can be engaged with either of the two engage holes 211 at the opposite ends of the outer sleeve 21. Thus, the length of the connecting rod 20 can be adjusted by pulling outward or pushing inward the two inner telescopic tubes 22 to enable membrane reels 70 of different lengths to be fitted between the two rolling members 40 on the two fixing plates 30.

In addition, a connecting plate 24 is further welded between the two outer sleeves 21 of the two connecting rods 20, making the two outer sleeves 21 shaped like an H for facilitating storing and assembling. In assembling, the two outer sleeves 21 have the opposite ends respectively fitted around the two inner telescopic tubes 22, letting the engage hole 211 of the outer sleeve 21 aligned to the projecting stud 61 protruding out of the through hole 221 of the inner telescopic tube 22. Then, a proper engage hole 211 of the outer sleeve 21 and the projecting stud 61 of the inner telescopic tube 22 are engaged with each other to finish the assembly of the two connecting rods 20, quick and convenient in assembly. Additionally, one of the two outer sleeves 21 has its two locations spaced apart respectively welded with a hooking ring 23 for hooking and positioning two ends of a tightening belt 50.

As can be understood from the above description, this invention has the following advantages.

1. The two connecting rods 20 of the dispenser 10 are adjustable in length; therefore, membrane reels of different lengths can be fitted between the two rolling members 40 for pasting membrane 71 on different-sized windows, heightening efficiency of membrane pasting work.

2. The two adjustable connecting rods 20 of the dispenser 10 can be fixed in position by mutual engagement of the elastic engage element 60 of the inner telescopic tube 22 and the engage hole 211 of the outer sleeve 21. To adjust the length of the two connecting rods 20, simply press downward the projecting stud 61 of the engage element 60 and then pull outward or push inward the inner telescopic tube 22, quick and convenient in handling.

While the preferred embodiments of the invention have been described above, it will be recognized and understood that various modifications may be made therein and the appended claims are intended to cover all such modifications that may fall within the spirit and scope of the invention.

1. A window membrane protective dispenser comprising
Two connecting rods having opposite ends respectively secured with a fixing plate, each said fixing plate having its inner wall symmetrically and pivotally provided with a rolling member at a preset location, a membrane reel able to be fitted between said two rolling members, said membrane reel rotated together with said two rolling members to release and paste membrane on a window glass, a tightening bolt fixed on one of said two connecting rods, said tightening belt fastening said applicator on a user's waist; and,
Characterized by said two connecting rods respectively consisting of at least one outer sleeve and one inner telescopic tube, said inner telescopic tube movably fitted in said outer sleeve, one of said two inner telescopic tubes provided thereon with at least one elastic engage element, one of said outer sleeves provided with engage holes preset in number, said elastic engage element and said engage hole able to be engaged with each other after said inner telescopic tube and said outer sleeve are pulled outward or pushed inward for a proper distance, the distance between said two rolling members on said two fixing plates able to be adjusted by lengthening or shortening said two connecting rods, membrane reels of different lengths able to be assembled between said two rolling members.

2. The window protective membrane dispenser as claimed in claim 1, wherein said two connecting rods respectively have one of said outer sleeves and one of said inner telescopic tubes respectively having one end welded on the inner wall of said fixing plate and the other end fitted with each other, one of said two inner telescopic tubes having the outer wall of its fitted end lengthwise provided with two protruding-out elastic engage elements spaced apart in line, one of said outer sleeves having the outer surface of its inner end bored with an engage hole corresponding with said elastic engage element, said engage hole of said outer sleeve able to engage with either of said two elastic engage elements.

3. The window protective membrane dispenser as claimed in claim 1, wherein said two connecting rods respectively comprise one outer sleeve and two opposite inner telescopic tubes, said two inner telescopic tubes respectively having one end fixedly welded on the inner wall of a fixing plate, said two inner telescopic tubes respectively having the other end fitted in the opposite ends of one of said outer sleeves, each said inner telescopic tube having the outer surface of the inner end provided with a projecting-out elastic engage element, the one of said outer sleeves having the outer surface of its inner ends respectively and lengthwise bored with two engage holes spaced apart in line, said elastic engage element of said inner telescopic tube able to be engaged with either of said two engage holes of said outer sleeve.

4. The window protective membrane dispenser as claimed claim 2, wherein said engage element is a V-shaped elastic strip which is received in said inner telescopic tube in advance, said engage element having the outer surface of one end provided with a projecting stud, said projecting stud able to elastically extend out of the through hole in the wall of said inner telescopic tube, said protecting stud able to be elastically engaged with said engage hole of said outer sleeve.

5. The window protective membrane dispenser as claimed in claim 2, wherein two hooking rings are respectively welded at a preset position on the outer surface of one of said outer sleeves and one of said inner telescopic tubes for hooking two ends of a tightening belt.

6. The window protective membrane dispenser as claimed in claim 3, wherein one of said outer sleeves has its opposite ends respectively welded thereon with a hooking ring for hooking and positioning two ends of a tightening belt.

7. The window protective membrane dispenser as claimed in claim 3, wherein a connecting plate is welded between said two outer sleeves of said two connecting rods for fixing the distance between said two connecting rods.

8. The window protective membrane dispenser as claimed claim 3, wherein said engage element is a V-shaped elastic strip which is received in said inner telescopic tube in advance, said engage element having the outer surface of one end provided with a projecting stud, said projecting stud able to elastically extend out of the through hole in the wall of said inner telescopic tube, said protecting stud able to be elastically engaged with said engage hole of said outer sleeve.
